(19) United States
(12) Patent Application Publication
(10) Pub. No.: US 2014/0040191 A1
(43) Pub. Date: Feb. 6, 2014

(54) INVENTORYING AND COPYING FILE SYSTEM FOLDERS AND FILES

(71) Applicants: A Charles BEDDOE, HARVARD, MA (US); JAMES T ANASTASI, LONDONDERRY, NH (US); RICHARD B KNOWLES, CHELMSFORD, MA (US)

(72) Inventors: A Charles BEDDOE, HARVARD, MA (US); JAMES T ANASTASI, LONDONDERRY, NH (US); RICHARD B KNOWLES, CHELMSFORD, MA (US)

(21) Appl. No.: 13/955,056

(22) Filed: Jul. 31, 2013

Related U.S. Application Data
(60) Provisional application No. 61/678,321, filed on Aug. 1, 2012.

(51) Int. Cl. G06F 17/30

(52) U.S. Cl. CPC G06F 17/30174
USPC 707/610

(57) ABSTRACT

Described is a system and method that facilitates fast and reliable discovery, enumeration, and processing of network shared resources. A file system processing subsystem (date engine) operates in a combined discovery, enumeration, and processing manner to provide access and operation as directed by the client to effect data collection and copying. The discovery, enumeration, and action operations use parallel operation and I/O (input/outputA) pipelining. Multiple threads are used during this process to enumerate each object's children, and enqueues each child to be handled by a new thread. For each network object discovered, the subsystem creates an object embodying operation and context information, and queues that object as a self-contained, asynchronous work item for a process thread pool to handle.

### CROSS REFERENCE TO RELATED APPLICATIONS

This application claims the benefit under 35 U.S.C. §119(e) of U.S. Provisional Patent Application Ser. No. 61/678,321 entitled “Inventorying and Copying File System Folders and Files”, filed Aug. 1, 2012, the entire contents of which is incorporated by reference.

### FIELD OF THE INVENTION

The present invention relates generally to computer system data storage, and more particularly to shared network resources, including share, folders, and files.

### BACKGROUND

File systems and data on networked computers need to be duplicated for a variety of reasons, including—but not limited to—backup and restoration, migration, synchronization, duplication, collaboration, provisioning new servers. As a result, various mechanisms have been developed for copying network data among storage servers.

Information about what is contained on networked storage systems is necessary for management of physical and logical resources, for security purposes, for accessibility, and for decision making. The acquisition and analysis of this information is problematic in most network environments due to its complexity and the latency in network I/O.

The existing software tools for inventory, copy, and movement of data and file systems are relatively slow and have suffered from performance and reliability problems and from a lack of scalability to modern large-capacity storage systems. What is needed is a fast, efficient, scalable means for managing large network file storage systems.

### SUMMARY OF THE INVENTION

Briefly, the present invention is directed toward an asynchronous, overlapped method that facilitates the discovery and collection of hierarchical file system data, copying of folders and files, and creation of shares in a networked storage environment. To this end, the DataEngine subsystem operates in a queued, asynchronous series of operations on file system objects to achieve parallelization of synchronization, copying, and/or data collection with multi-threaded operations.

The DataEngine is invoked by the user interface program to perform a Copy, Delete, or Inventory operation on a file system object or tree.

The file system tree is processed top-down and each node (folder or file) is processed by queuing an appropriate operation on that item. The DataEngine manages the thread pool by taking items from the queue to assign to available threads. Once an operation is assigned to a thread it is executed entirely asynchronously to completion; there are no synchronization callbacks or other synchronizing mechanisms. Data collection and logging are accomplished with calls to asynchronous data collection and logging threads.

As each operation enumerates new folders, those folder operations are queued for enumeration by another thread. It is thus possible for a folder and its subfolders to be processed in parallel on separate threads. This takes advantage of I/O parallelization over the network, reducing the effect of latency by more effective utilization of network capacity on the total time to process the entire tree.

During the operation, an exception list containing the names of folders and files that were not correctly processed (e.g. due to security or IO errors) is generated.

At the completion of the operation, the exception list may be processed to retry operations that did not complete successfully, including logging of the retries.

### BRIEF DESCRIPTION OF THE DRAWINGS

FIG. 1 is a block diagram generally representing a computing environment into which the present invention may be incorporated.

FIG. 2 is a block diagram comprising a general example architecture for implementing copy with a fast and reliable file system subsystem in accordance with various aspects of the present invention.

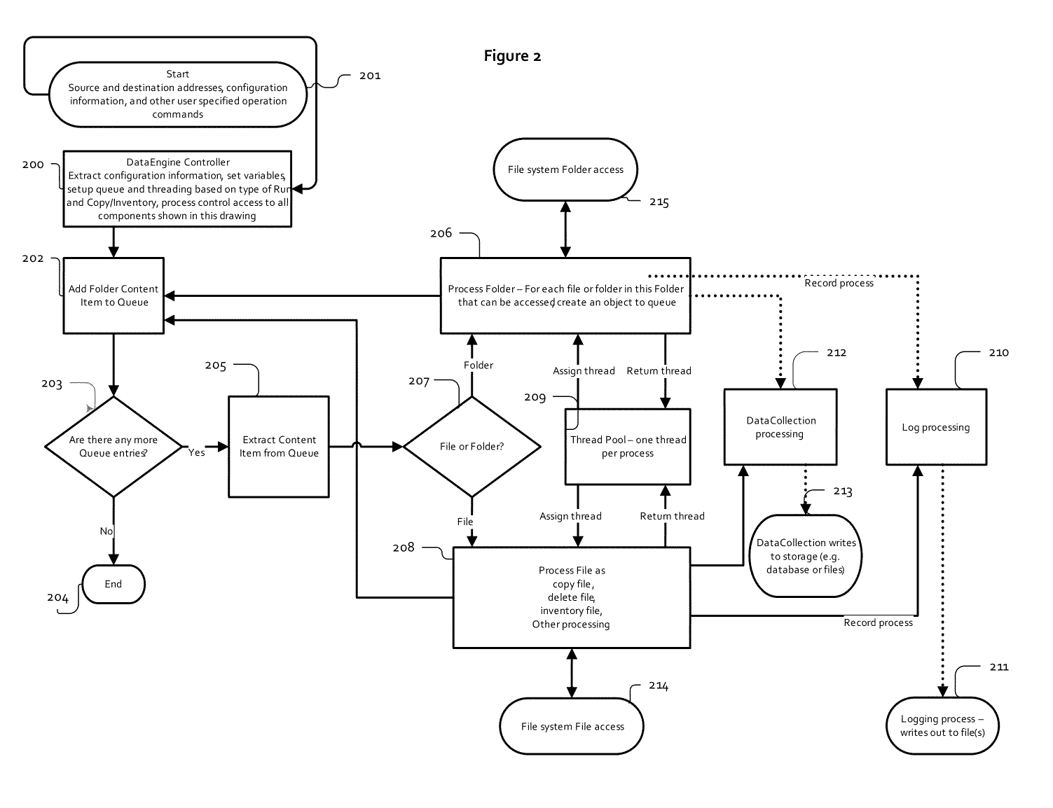

FIG. 3 is a diagram of an implementation of a Sync Copy.

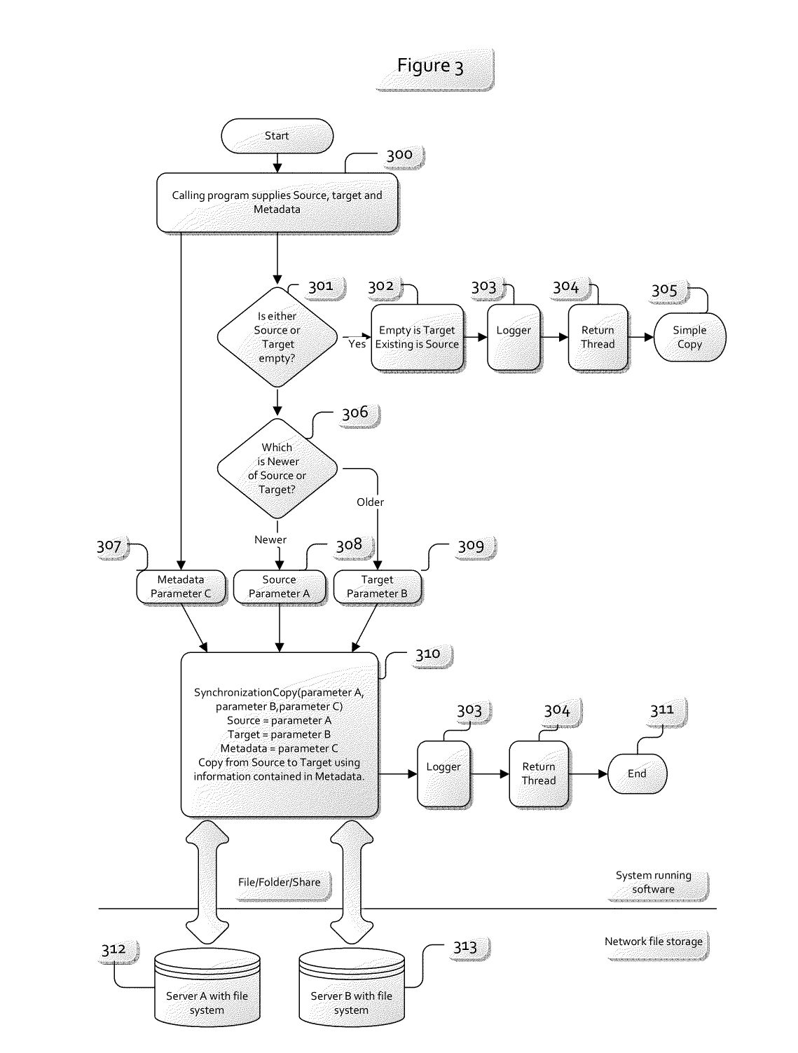

FIG. 4 is a diagram of an implementation of queue management.

FIG. 5A is a diagram of an implementation of a Folder Operation.

FIG. 5B is a diagram of an implementation of a File Operation.

FIG. 6 is a diagram of a logging process.

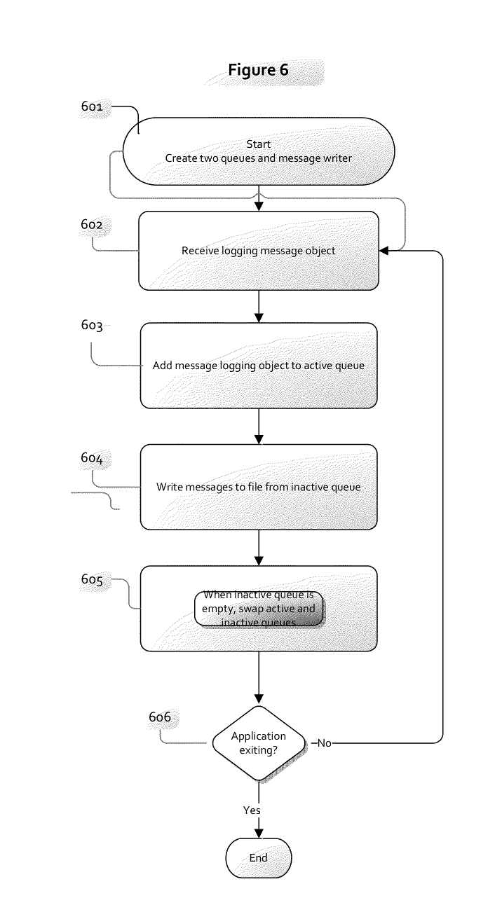

FIG. 7 is a diagram of a data collection process.

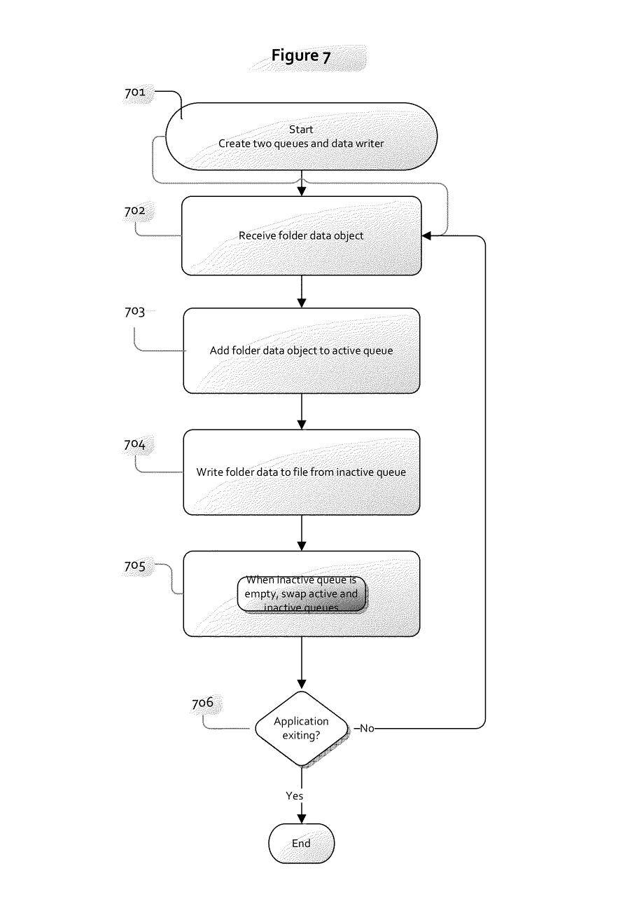

FIG. 8 is a diagram of an embodiment of a folder operator.

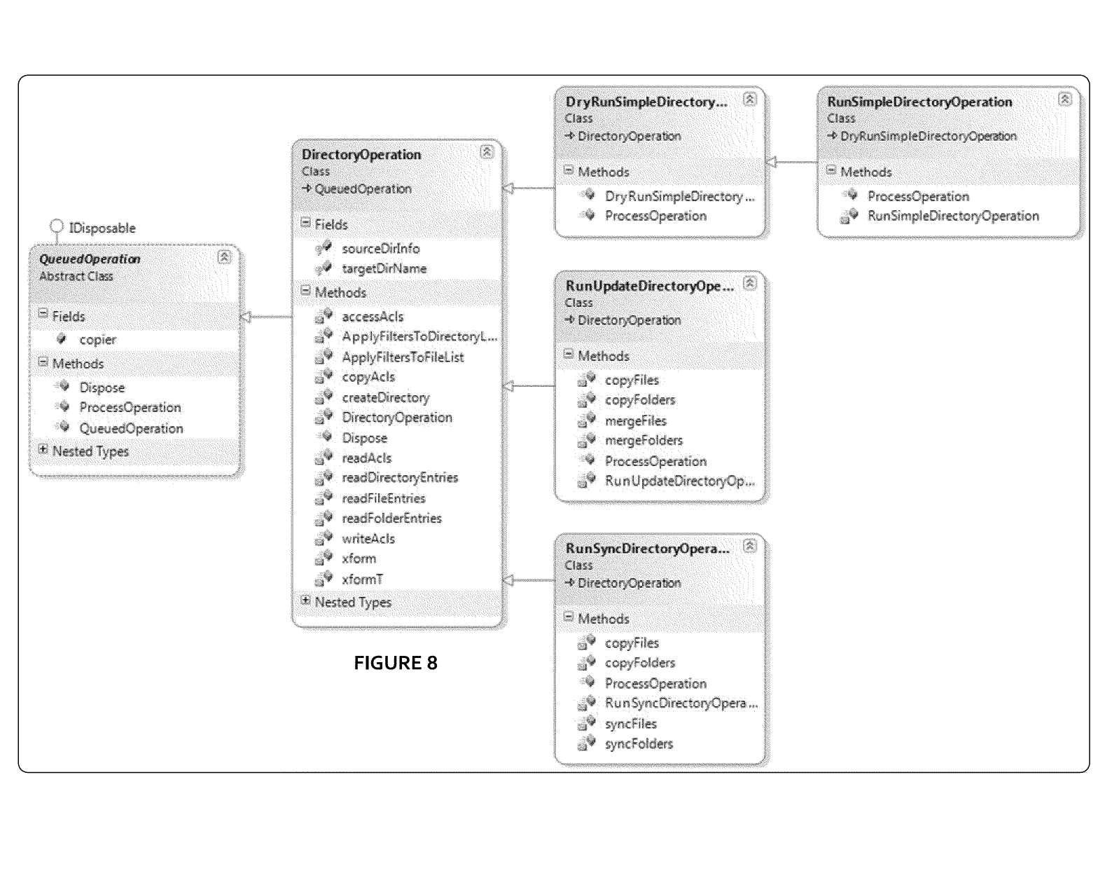

### DETAILED DESCRIPTION

One example of a suitable computing system environment on which the invention may be implemented is a Microsoft Windows™ Server operating in a Microsoft Windows™ network. This computing system environment is only one example of a suitable computing environment and is not intended to suggest any limitation as to the scope of use or functionality of the invention. Neither should the computing environment be interpreted as having any dependency or requirement relating to the Microsoft Windows™ Operating System.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like. The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

Inventorying, Copying, Deleting File System Folders and Files

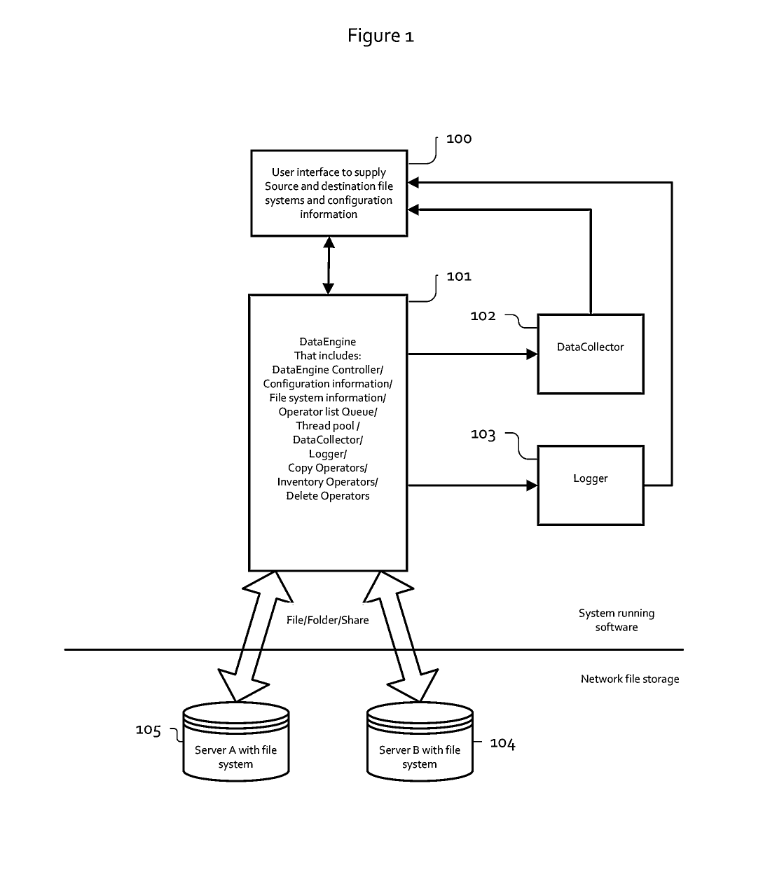

The present invention is generally directed towards a system and method by which File systems on network storage devices are inventoried and/or copied. To this end, the present invention walks the file system tree nodes of the specified source file system node and creates file system object operations that are queued for execution from a pool of available threads, including subsequent processing of subfolders. This method avoids the dangers of actual recursion. As will be understood, the subsystem in this implementation provides for significant parallel operation and I/O (input/output) pipelining, and thus facilitates rapid file system processing, whereby the subsystem is referred to herein (for brevity) as the DataEngine subsystem 101 (FIG. 1).

In general, in this example implementation, the DataEngine subsystem 101 component enumerates the folders and files of the source file system node and creates folder operation and file operation requests (Folder Operators and File Operators), and potentially creates a folder on a target file system in the case of Copy with associated folder metadata (attributes, dates, etc.) and Access Control Lists (ACLs).

Each Folder Operator and File Operator is executed entirely asynchronously from other Folder Operator and File Operator operations, the order of operation being determined by the order of queuing as determined by prior operations and obviating the need for costly synchronizing callbacks between or among the operators, since folder operations that processed the parent folders have already completed and exited upon enumeration of its folders and files.

The DataEngine 101 is initiated by a calling program 100 with a command (in this implementation Copy, Sync, or Inventory), a Source folder path and name, and a Target folder path and name(ignored in the case of Inventory). The command will cause an access to Server A 105 as the source of the Copy, Inventory, or Delete command and in the case of Copy command, Server B 104 is also accessed as the destination location of the Copy command. After processing the file or folder according to the command, the result of the processing is sent to the logger program 103 to record the event. In the case of the Inventory command, an additional result is sent to the DataCollector 102 to record the File Object found by the processing. The result sent to the DataCollector 102 and Logger 103 is also sent back to the User interface 100.

The DataEngine creates a Folder Operator object 200 from the Source folder and queues 202 this object to initiate the process.

The Folder Operator 206 enumerates the contents of the folder and creates and queues Folder Operators 202 and File Operators 202 to perform operations on these file system entities. The DataEngine Controller 200 manages the thread pool 209 and the queue 202, assigning the next operator to the next available thread. The process terminates when the queue is empty and the threads are all idle.

In the case of Copy, a Folder Operator is an object that enumerates a folder and creates and queues Folder Operators 202 and File Operators 202 to perform operations on these file system entities. In the case of Inventory, a Folder Operator is an object that enumerates a folder and creates and queues Folder Operators 202, and collects information on folders and files that is reported to the DataCollector 2; no File Operators are created in an Inventory operation. All folder and File Operators report progress and error information to the Logger 210. The choice of information logged is controlled by options that are passed to the operators.

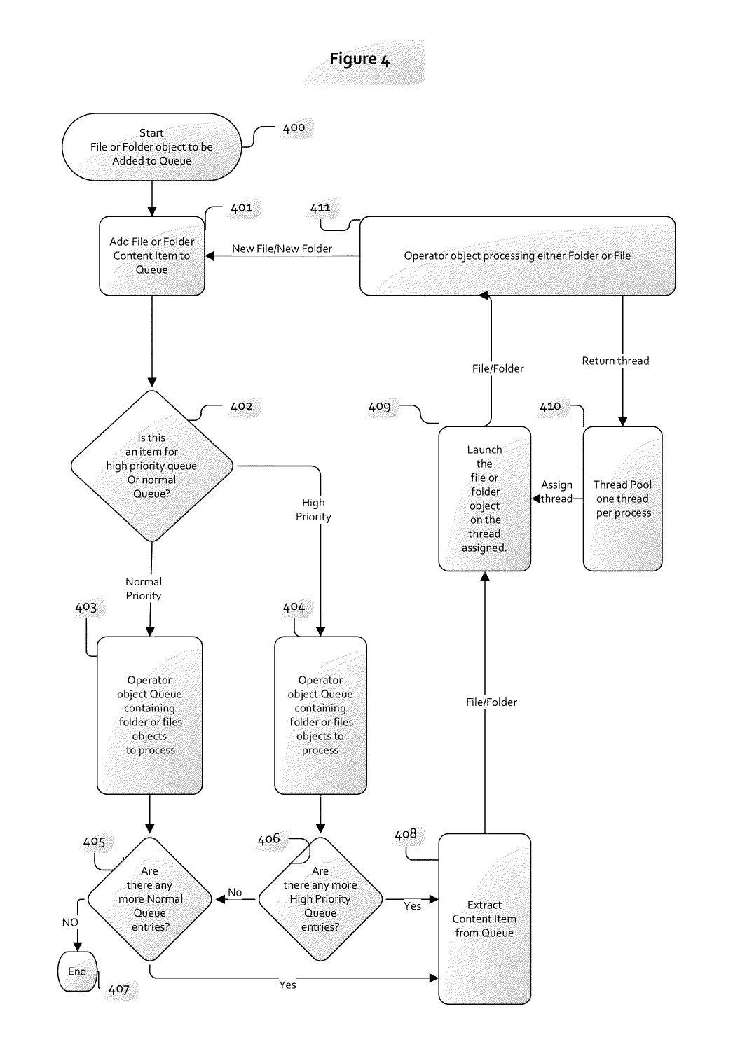

FIG. 4 shows the queuing and threading of the Folder and File Operators. An object is received by queuing process 401, identified by priority 402, and placed in the normal priority queue 403 or the high priority queue 404. Objects are removed from the queues 405, 406 and assigned to an available thread 409 and executed 411. As threads exit, they are returned to the thread pool 410.

A File Copy Operator copies a file from the source folder to the target folder using double-buffered, overlapped input/output operations in this implementation. This reduces the time to copy a file from 2n to n+1, where n is the number of reads or writes to span the entire file. A File Operator copies all file metadata and access control list contents from the source folder to the target folder. A File Operator logs progress and error messages, gated by the logging options.

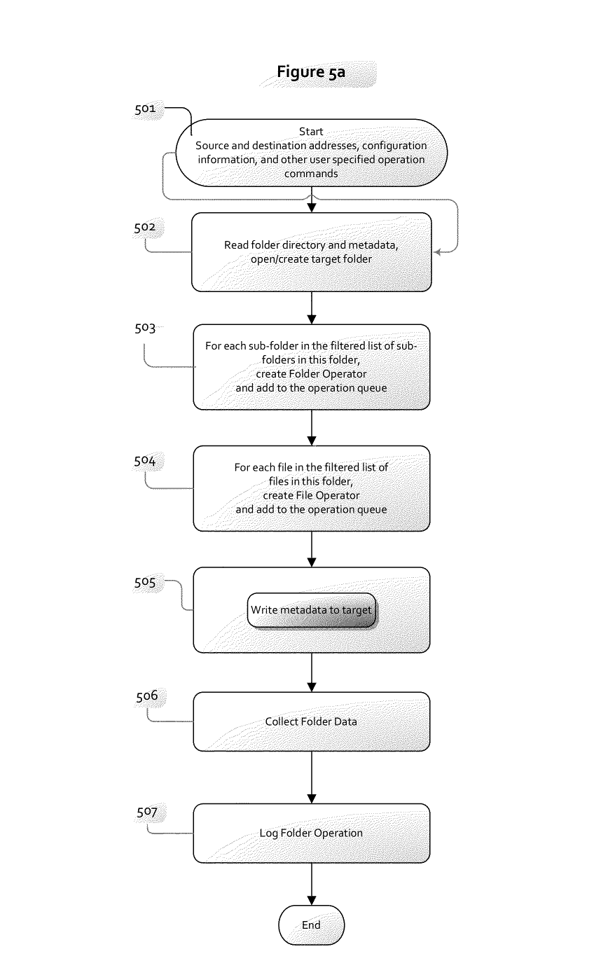

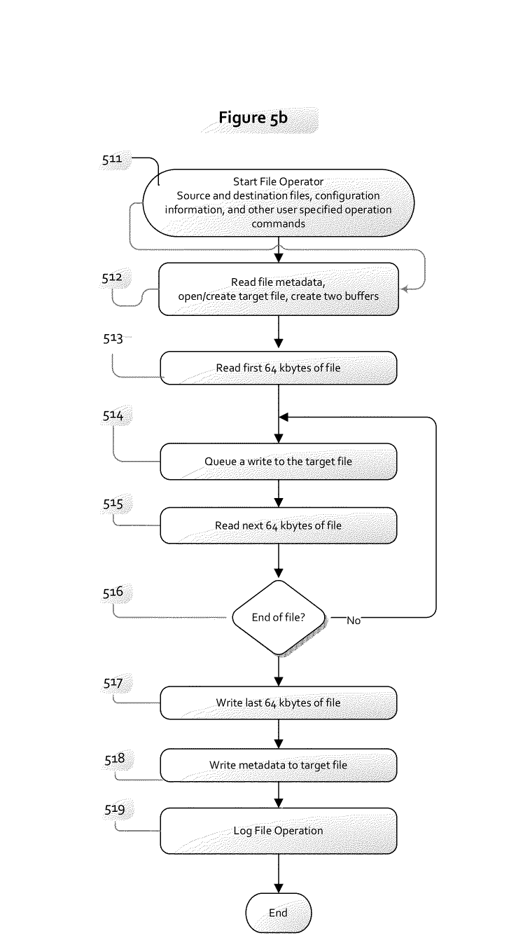

There are multiple types of Folder Operators to accomplish various types of copy operations, including but not limited to Simple Copy, Update Copy, and Synchronization Copy. The selection of folders and files may be filtered by name, date and time, and/or attributes. Folder and File Filters may be specified to narrow the selection of file system objects that have operations applied to them by Folder and File Operators. FIG. 5a shows the common structure and process of all Folder Operators types. A folder's contents are read 502, filters are applied to the list of sub-folders and the resulting folders have Folder Operators queued 503. Similarly, filters are applied to the list of sub-files and the resulting files have File Operators queued 504. The target folder's metadata are updated 505, the summary data of the folder contents are collected 506, and the enumeration of the folder is logged 507.

The Simple Copy Folder Operator copies all folders and files with their associated metadata and ACLs from the source folder without regard to the content of the target folder. The Simple Copy Folder Operator queues Simple Copy Folder Operators for its subfolders.

The Update Copy Folder Operator copies all folders and files with their associated metadata and ACLs from the source folder when the file in the source folder is different from target folder in regard to size or date, or when the folder or file does not exist on the target. When a folder in the target does not exist, the Update Copy Folder Operator no longer queues Update Folder Operators but optimizes by queuing Simple Copy Folder Operators thus saving performing read operations on the target device for subsequent operations.

The Synchronization Copy Folder Operator copies all folders and files with their associated metadata and ACLs from the source folder to the target folder when the file in the source folder is newer 306 than the file in target folder or does not exist in the target folder 301 and copies all folders and files with their associated metadata and ACLs from the target folder to the source folder when the file in the target folder is newer 306 than the file in source folder or does not exist 301 in the source folder. To implement this processing there is only one Synchronization Operator and the parameters for source and target folders are swapped 306 when calling the Operator. When a folder in the source does not exist on the target 302, the Synchronization Copy Folder Operator no longer queues Synchronization Folder Operators but optimizes by queuing Simple Copy Folder Operators 305 thus saving performing read operations on the target device for subsequent operations. Following each Copy action the activity is recorded in the Logger 303 followed by returning the Thread 304.

The Folder Inventory Operator enumerates the folders and files to create a data record 212 for transmission to the DataCollector 213 and then sends a message to the Logger 210. It creates 206 and queues 202 a Folder Inventory Operator for each of its subfolders.

The Folder Delete Operator enumerates the folders down to the leaf level where upon reading the folder size metadata and finding zero size or empty contents, the Operator will remove the current Folder.

FIG. 5b shows the process of the File Operator to accomplish file transfer from source to target. The operation begins by creating two input/output buffers, opening the source file, reading its metadata 512. The file is read and written in a double-buffered, overlapped manner 513, 514, 515 until the end of the source file is reached 516, and the last buffer written to the target 517. The file metadata is updated 518 and the operation is logged 519. The thread exits.

The File Delete Operator is queued by another Operator. In the case of Copy type Operator following a successful copy operation, and if the Delete Operator is active then Copy will queue a Delete Operator on that File and the Copy operation completes.

The Logger is a process running on its own thread that embodies a dual queue and a writer 601. Folder and File Operators add messages 602 to the queue in memory 603 and the Logger asynchronously writes the log entries to a file 604 in this implementation. The process is non-blocking due to the use of two queues, active and inactive 605. The thread shuts down upon DataEngine exit 606.

The DataCollector is a process running on its own thread that embodies a dual queue and a writer 701. Folder and File Operators add inventory data objects 702 to the queue in memory 703 and the DataCollector asynchronously writes the log entries to a database 704 in this implementation. The process is non-blocking due to the use of two queues, active and inactive 705. The thread shuts down upon DataEngine exit 706.

What is claimed is:

1. In a computing environment, a computer-implemented method for inventorying, copying, and synchronizing of file system folders and content, the method comprising:
enumerating the folder structures, creating and queuing operations for each folder and file therein on separate threads of operation, managing the queue and thread pool for the parallel operation of folder and file operators, creating log messages for information of the operators, creating data objects containing full description of the folders, managing the logging of operational information from the folder and file operators, managing the collection of data from the inventory operators, application of filters to direct the creation of folder and file operators, and providing real-time summary information on the progress of the operations.

2. The method of claim 1 further comprises: self-adjusting priority queue management based on type of operation and thread pool utilization.

3. The method of claim 1 further comprises: resource sensitive self-adjusting thread management based on CPU utilization, the number of processor units, memory utilization, and/or memory size.

4. The method of claim 3 further comprises: self-adjusting thread management based on network utilization and throttling parameters.

5. The method of claim 1 further comprises: folder filtering based on names, collections of names, and patterns of names.

6. The method of claim 1 further comprises: file filtering based on names, collections of names, and patterns of names.

7. The method of claim 1 further comprises: source folder filtering based on dates and times being the same as, earlier than, and/or later than a specified date and/or time.

8. The method of claim 1 further comprises: source file filtering based on dates and times being the same as, earlier than, and/or later than a specified date and/or time.

9. The method of claim 1 further comprises: an extensible set of folder operators as required for functionality . . .

10. The method of claim 1 further comprises: an extensible set of file operators as required for functionality . . .

11. The method of claim 9, wherein a folder operator queues folder operators for each child folder.

12. The method of claim 9, wherein a folder operator queues file operators for each file contained in the folder.

13. The method of claim 10, wherein file input/output (1/0) operations for a file copy operation are overlapped.

14. The method of claim 11 combined with claim 12, wherein the combined set of operators at each single folder level eliminates the requirement for synchronization between operators at that level and between multiple levels of operators as they only operate at that level.
